(19) United States
(12) Patent Application Publication
(10) Pub. No.: US 2024/0392623 A1
(43) Pub. Date: Nov. 28, 2024

(54) POCKET DOOR FRAME

(71) Applicant: The Marwin Company, Inc., West Columbia, SC (US)

(72) Inventor: Alan Collier MEEKS, Blythewood, SC (US)

(73) Assignee: The Marwin Company, Inc., West Columbia, SC (US)

(21) Appl. No.: 18/672,767

(22) Filed: May 23, 2024

Related U.S. Application Data
(60) Provisional application No. 63/503,753, filed on May 23, 2023.

(51) Int. Cl. E06B 3/46

(52) U.S. Cl. CPC E06B 3/4654

(57) ABSTRACT

A pocket wall door frame may be provided. The pocket wall doorframe may have vertical supports that hold a plurality of slats. A universal or pre-cut header may be adhered at the top of the vertical supports. A pocket door may be installed in the pocket door frame and may use a stud of the wall as a backstop.

### RELATED APPLICATION/S

This application claims the benefit of priority under 35 USC § 119 (e) of U.S. Provisional Patent Application No. 63/503,753 filed May 23, 2023, the contents of which are incorporated herein by reference in their entirety.

### FIELD OF THE INVENTION

The present invention, in some embodiments thereof, relates to the construction industry and, more particularly, but not exclusively, to a door frame.

### BACKGROUND OF THE INVENTION

Pocket doors are a common way of saving space in houses or other buildings where space is at a premium. Currently most pocket doors use either a “knocked down” door frame or a pre-assembled door frame with a backboard. Knocked down door frames are more flexible and often use a universal or adjustable header, however knocked down door frames need to be assembled on site by skilled laborers, increasing the complexity and cost of installing them. Pre-assembled door frames on the other hand are simpler to install, however each pre-assembled door frame needs to be tailored specifically to the door and wall it is going to be installed in to determine the backboard stop and the header size. This increased need for customization increases the burden for manufacturing, and therefore the cost of the frame to consumers.

### SUMMARY OF THE INVENTION

A pocket wall door frame may be provided. The pocket wall doorframe may have vertical supports that hold a plurality of slats. A universal or pre-cut header may be adhered at the top of the vertical supports. In some embodiments the frame may be made of, for example, wood, while the vertical supports may be a different material, for example metal. A pocket door may be installed in the pocket door frame and may use a stud of the wall as a backstop.

According to an aspect of some embodiments of the present invention there is provided a pocket door frame, comprising: a back frame portion; and, a front frame portion, wherein each of the back frame portion and the front frame portion have a first vertical support and a second vertical support.

In an embodiment of the invention, the back frame portion and the front frame portion are made of at least one of a composite material, wood, steel, and reinforced plastic.

In an embodiment of the invention, the first support and the second support are constructed of the same material as the back frame portion and the front frame portion.

In an embodiment of the invention, the first support and the second support are constructed of a different material as the back frame portion and the front frame portion.

In an embodiment of the invention, the pocket door frame further comprises a plurality of slats between the first vertical support and the second vertical support.

In an embodiment of the invention, the slats are made of the same material as the back frame portion and the front frame portion.

In an embodiment of the invention, the slats are made a different material as the back frame portion and the front frame portion.

In an embodiment of the invention, the slats are at least one of screwed into, glued to, bolted to, and adhered to the vertical supports.

In an embodiment of the invention, the pocket door frame further comprises a track or lip disposed on the first support and the second support to assist in securely holding the slats.

In an embodiment of the invention, the slats are adjustable along the track or lip before being adhered to the track or lip.

In an embodiment of the invention, the pocket door frame further comprises a middle support.

In an embodiment of the invention, the middle support is adhered to the second vertical support.

In an embodiment of the invention, the pocket door frame further comprises a header, which disposed at the top of the first support and the second support.

In an embodiment of the invention, the header is pre-sized for the installation application or is manufactured in a universal size which is later cut to correct installation dimensions on site.

In an embodiment of the invention, the header further comprises a horizontal support.

In an embodiment of the invention, the pocket door frame further comprises a doorstop attached to a door to be installed in the pocket door frame, the pocket door frame or on a stud opposite the pocket door frame.

According to a further aspect of some embodiments of the present invention there is provided a method of installing a pocket door frame, comprising: pre-building the pocket door frame according to claim 1 before installation into a wall pocket; using one or more existing wall studs as a backstop regardless of a set length of one or more slats of the pocket door frame.

In an embodiment of the invention, the method further comprises utilizing a doorstop, wherein the doorstop is attached in the pocket door frame, the pocket door frame or on a stud opposite the pocket door frame and wherein the doorstop acts as a cushion when the door makes contact with the stud.

According to an aspect of some embodiments of the present invention there is provided a pocket door frame to be used in the installation of pocket doors with a size larger than the size of the pocket door frame, comprising: a header having an extended header portion that extends past a back end of the pocket door frame, wherein the extended header portion corresponds to a specific pocket door size or is universally sized, to be cut to a specific size in situ.

In an embodiment of the invention, the extended header portion includes at least one indicator of what size is appropriate for various pocket doors.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example, are not necessarily to scale and are for purposes of illustrative discussion of embodiments of the invention. In this regard, the description taken with the drawings makes apparent to those skilled in the art how embodiments of the invention may be practiced.

In the drawings:

FIG. 1 is an isometric view of an exemplary pocket door frame, in accordance with an exemplary embodiment of the invention;

FIG. 2 is a front view of an exemplary pocket door frame, in accordance with an exemplary embodiment of the invention;

FIG. 3 is a left view of an exemplary pocket door frame, in accordance with an exemplary embodiment of the invention;

FIG. 4 is a right view of an exemplary pocket door frame, in accordance with an exemplary embodiment of the invention;

FIG. 5 is a top view of an exemplary pocket door frame, in accordance with an exemplary embodiment of the invention;

FIG. 6 is a bottom view of an exemplary pocket door frame, in accordance with an exemplary embodiment of the invention; and,

FIG. 7 is a second exemplary pocket door frame, in accordance with an exemplary embodiment of the invention.

### DESCRIPTION OF SPECIFIC EMBODIMENTS OF THE INVENTION

The present invention, in some embodiments thereof, relates to the construction industry and, more particularly, but not exclusively, to a door frame.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

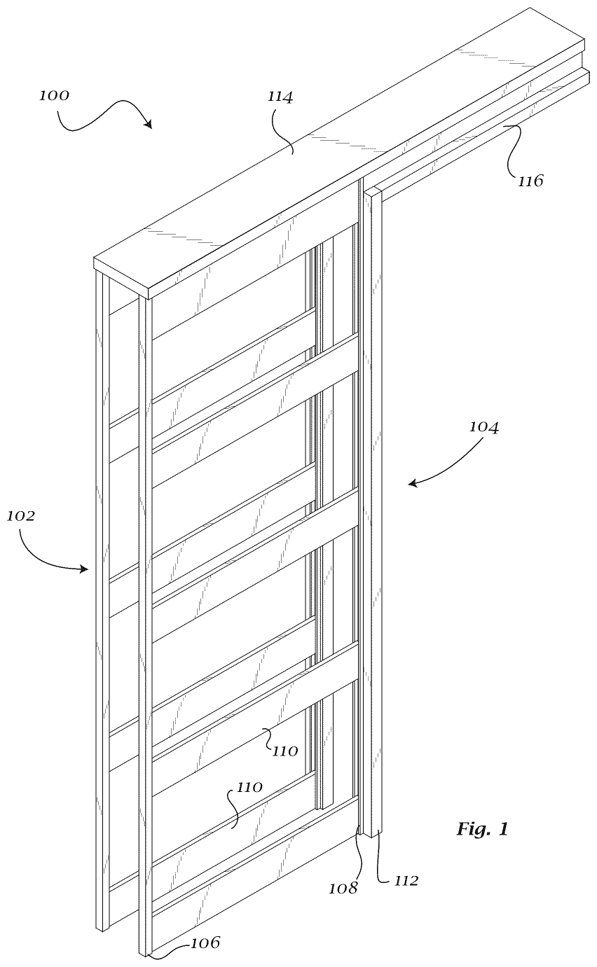

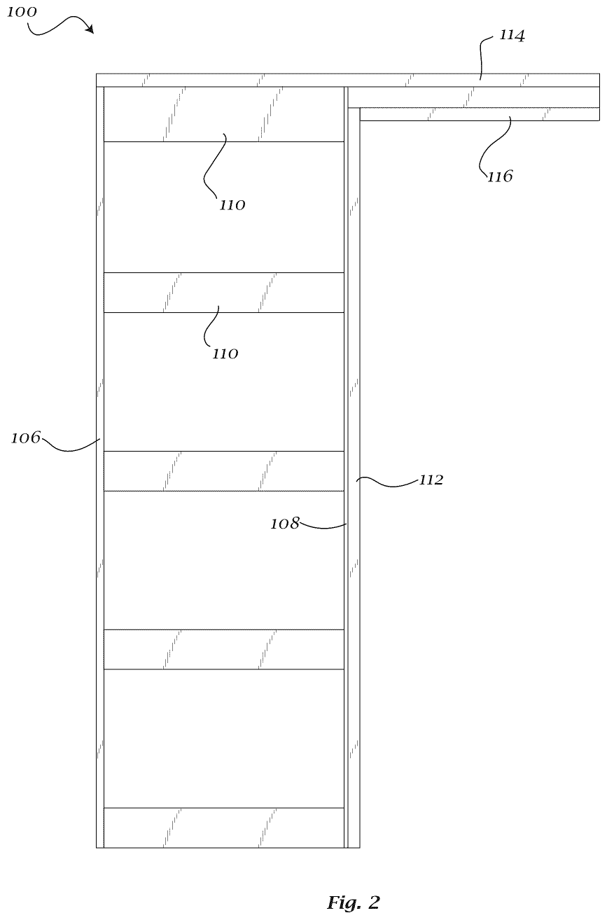

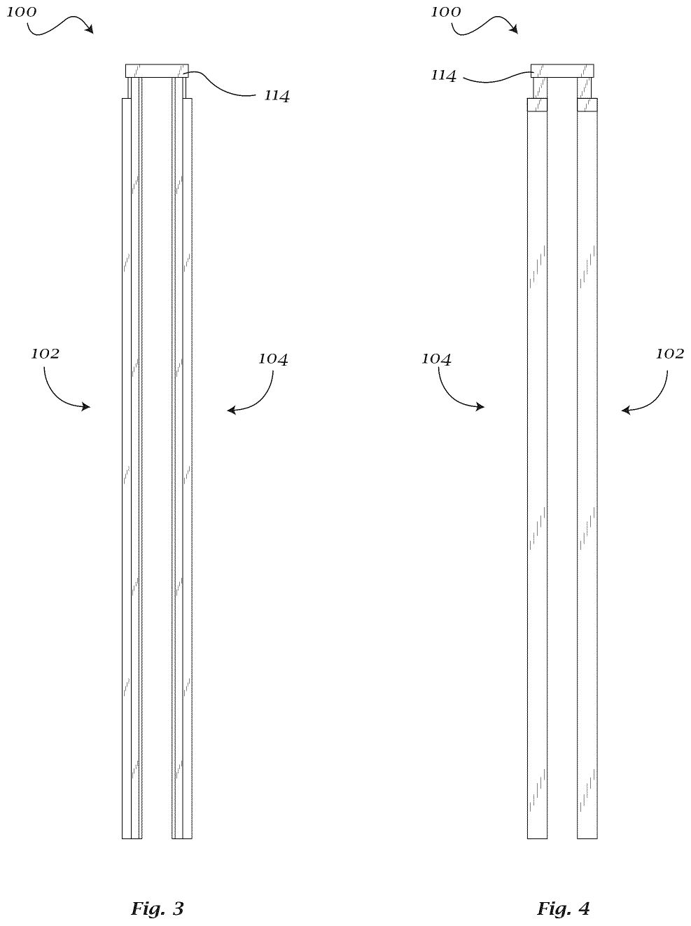

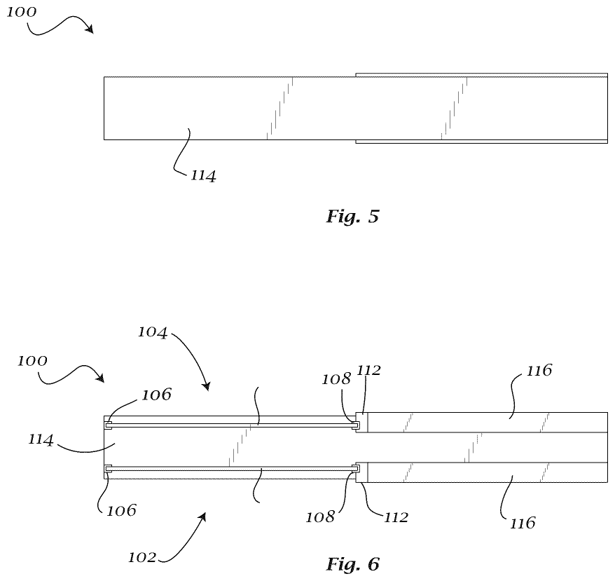

Referring to FIGS. 1-6, FIG. 1 shows an isometric view of an exemplary pocket door frame 100. FIGS. 2-6 show other views of the exemplary pocket door frame 100. FIG. 2 shows a front view of an exemplary pocket door frame 200. FIG. 3 shows a left view of an exemplary pocket door frame 300. FIG. 4 shows a right view of an exemplary pocket door frame 400. FIG. 5 shows a top view of an exemplary pocket door frame 500. FIG. 6 shows a bottom view of an exemplary pocket door frame 600.

The exemplary pocket door frame may have a back frame portion 102 and a front frame portion 104. The back frame portion 102 and the front frame portion 104 may be made of, for example, a composite material such as, but not limited to, wood, steel, reinforced plastics, etc. each of the back frame portion 102 and the front frame portion 104 may have a first vertical support 106 and a second vertical support 108. The first support 106 and the second support 108 may be the same material as the back frame portion 102 and the front frame portion 104 or may be a different material. For example, in an embodiment, the back frame portion 102 and the front frame portion 104 may be made of wood while the first support 106 and the second support 108 may be made of metal. There may further be a plurality of slats 110 between the first vertical support 106 and the second vertical support 108. The slats 110 may be the same material and the back frame portion 102 and the front frame portion 104 or may be a different composite material. In some embodiments the slats 110 may be, for example but not limited to, screwed into, glued to, bolted to, or otherwise adhered to the vertical supports.

In some embodiments the first support 106 and second support 108 may further have a track or lip, which may assist in securely holding the slats 110. In some embodiments the slats 110 may be adjustable along the track or lip, before being adhered to them. The exemplary pocket door frame may further have a middle support 112. The middle support may be adhered to the second vertical support 108. The exemplary pocket door frame may further have a header 114, which may be at the top of the first support 106 and the second support 108. In some embodiments the header 114 may be pre-sized for the installation application, while in other embodiments the header may be a universal size and may be cut to the correct dimensions on site. The header may further have a horizontal support 116.

It may be understood that in an embodiment the length of the slats 110 may be a set length, for example 2/0 or 4′ 2″ length. In the embodiment a plurality of sliding door sizes may be accommodated by the door. For example, a 3/0 or 6′2″ length door may be accommodated. In the embodiment the frame may be pre-built before installation into the wall pocket. At the time the frame is installed the one or more existing wall studs, for example a 2×4 wall stud, may act as a backstop, regardless of the set length of the slats of the exemplary pocket door frame. It may be understood that the door may continue past the end of the door frame. In some embodiments a doorstop may be utilized, the doorstop may be placed on the stud or door to be installed in the pocket door frame as needed. The doorstop may act as a cushion when the door makes contact with the stud. The doorstop may be, for example, rubber, plastic, fabric, metal, or another material.

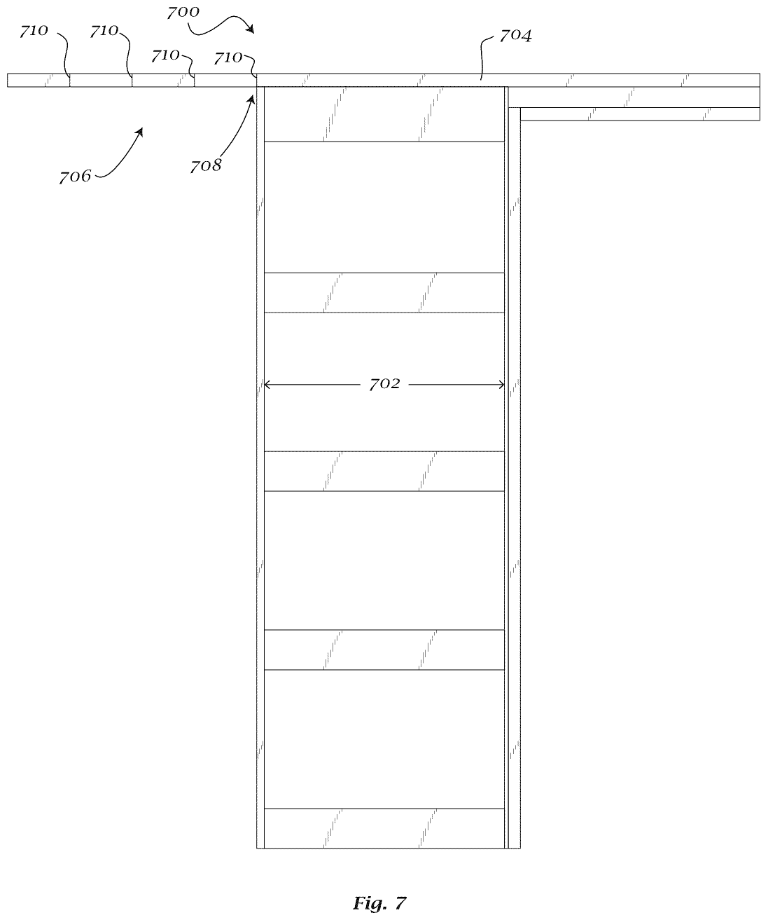

Referring to FIG. 7 a second exemplary pocket door frame 700 may be shown. The pocket door frame 700 may be used in installation of pocket doors with a size larger than the size of the pocket door frame's 700 frame size 702. For example, the pocket door frame 700 may have a 2/0 frame size 702, while the pocket door to be installed may have a size of 3/0. The pocket door frame 700 may have a header 704. The header 704 may have an extended header portion 706 that extends past a back end 708 of the pocket door frame 700. It may be understood that the extended header portion 706 may correspond to a specific pocket door size, e.g. 3/0 or 2/8. In some embodiments the extended header may be cut to a specific size in order to accommodate different pocket doors. In some embodiments the extended header portion 706 may have notches 710 or other indications of what size is appropriate for various pocket doors, for example a notch 710 on where the extended header portion 706 needs to be cut for a 2/4, 2/6, and/or 2/8 size pocket door.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

The term “plurality” means “two or more”.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A pocket door frame, comprising:
a back frame portion; and,
a front frame portion,
wherein each of the back frame portion and the front frame portion have a first vertical support and a second vertical support.

2. The pocket door frame according to claim 1, wherein the back frame portion and the front frame portion are made of at least one of a composite material, wood, steel, and reinforced plastic.

3. The pocket door frame according to claim 1, wherein the first support and the second support are constructed of the same material as the back frame portion and the front frame portion.

4. The pocket door frame according to claim 1, wherein the first support and the second support are constructed of a different material as the back frame portion and the front frame portion.

5. The pocket door frame according to claim 1, further comprising a plurality of slats between the first vertical support and the second vertical support.

6. The pocket door frame according to claim 5, wherein the slats are made of the same material as the back frame portion and the front frame portion.

7. The pocket door frame according to claim 5, wherein the slats are made a different material as the back frame portion and the front frame portion.

8. The pocket door frame according to claim 5, wherein the slats are at least one of screwed into, glued to, bolted to, and adhered to the vertical supports.

9. The pocket door frame according to claim 5, further comprising a track or lip disposed on the first support and the second support to assist in securely holding the slats.

10. The pocket door frame according claim 9, wherein the slats are adjustable along the track or lip before being adhered to the track or lip.

11. The pocket door frame according to claim 1, further comprising a middle support.

12. The pocket door frame according to claim 11, wherein the middle support is adhered to the second vertical support.

13. The pocket door frame according to claim 1, further comprising a header, which disposed at the top of the first support and the second support.

14. The pocket door frame according to claim 13, wherein the header is pre-sized for the installation application or is manufactured in a universal size which is later cut to correct installation dimensions on site.

15. The pocket door frame according to claim 13, wherein the header further comprises a horizontal support.

16. The pocket door frame according to claim 1, further comprising a doorstop attached to a door to be installed in the pocket door frame, the pocket door frame or on a stud opposite the pocket door frame.

17. A method of installing a pocket door frame, comprising:
pre-building the pocket door frame according to claim 1 before installation into a wall pocket;
using one or more existing wall studs as a backstop regardless of a set length of one or more slats of the pocket door frame.

18. The method according to claim 17, further comprising utilizing a doorstop, wherein the doorstop is attached in the pocket door frame, the pocket door frame or on a stud opposite the pocket door frame and wherein the doorstop acts as a cushion when the door makes contact with the stud.

19. A pocket door frame to be used in the installation of pocket doors with a size larger than the size of the pocket door frame, comprising:
a header having an extended header portion that extends past a back end of the pocket door frame, wherein the extended header portion corresponds to a specific pocket door size or is universally sized, to be cut to a specific size in situ.

20. The pocket door frame according to claim 19, wherein the extended header portion includes at least one indicator of what size is appropriate for various pocket doors.
